(19) United States
(12) Patent Application Publication
(10) Pub. No.: US 2026/0289396 A1
(43) Pub. Date: Sep. 24, 2026

(54) SYSTEM AND METHOD FOR UNCERTAINTY-WEIGHTED WEAKLY-SUPERVISED MULTI-MODAL TIME-SERIES PARSING

(71) Applicant: Mitsubishi Electric Research Laboratories, Inc., Cambridge, MA (US)

(72) Inventors: Moitreya Chatterjee, Boston, MA (US); Yung-Hsuan Lai, Taipei (TW); Janek Ebbers, Boston, MA (US); Michael Jones, Boston, MA (US); François G Germain, Boston, MA (US)

(73) Assignee: Mitsubishi Electric Research Laboratories, Inc., Cambridge, MA (US)

(21) Appl. No.: 19/087,787

(22) Filed: Mar. 24, 2025

(51) Int. Cl. G06N 20/00

(52) U.S. Cl. CPC G06N 20/00

(57) ABSTRACT

A system and method for multi-modal time-series parsing from weakly supervised data are disclosed. The method includes receiving a multi-modal input sequence comprising a plurality of segments, each containing data from at least one modality. A pre-trained pseudo-label generation model generates segment-level pseudo-labels by capturing temporal dependencies using a transformer-based architecture and extracting cross-modal correlations between different modalities. An uncertainty score is computed for each pseudo-label based on confidence measures derived from the model's predictions. An inference model is trained using uncertainty-weighted learning, optimizing event detection in a test multi-modal input sequence. The system implements these steps using a processor and memory storing executable instructions. Applications include real-time surveillance, autonomous vehicles, healthcare monitoring, sports broadcasting, and content moderation. The disclosure improves event detection accuracy, robustness against noisy labels, and adaptability to weakly supervised data.

### TECHNICAL FIELD

The present disclosure relates to machine learning and artificial intelligence, specifically to multi-modal time-series parsing under weak supervision. More particularly, the disclosure concerns methods and systems for training and/or adapting machine learning models for event detection and classification, in a time-series, when labeled data is limited, incomplete (i.e. weakly supervised). The disclosure is particularly applicable to multi-modal datasets, where event information is distributed across different modalities such as audio, video, and text.

### BACKGROUND

Transfer learning is a widely used technique in machine learning that enables models trained in one domain, where labeled data is abundant, to be adapted for use in a different domain, where labeled data is often scarce. This approach is particularly valuable in real-world scenarios where manually labeling large datasets is impractical or prohibitively expensive. Instead of training a model from scratch, using limited data from the target domain, transfer learning allows the model to leverage knowledge learned from a well-annotated source domain. However, while transfer learning has been successful in uni-modal applications, its application to multi-modal time-series parsing scenarios remains a significant challenge due to the complexities of handling multiple interrelated information streams such as from video, audio, and text.

One of the most pressing challenges in multi-modal transfer learning is the mismatch between the source and target domains. A model trained on a structured, fully labeled dataset with synchronized multi-modal inputs often performs poorly when applied to a target domain with weakly labeled, misaligned, or degraded data. For instance, an action recognition model trained on clean, high-resolution video with synchronized audio may struggle when applied to low-resolution security footage with intermittent sound. The statistical distributions of features in the source and target domains may differ significantly, making it difficult for the model to generalize effectively across datasets.

Even when an event is conceptually similar across domains, its representation in different modalities can vary substantially. Consider an event detection model trained to recognize musical performances in a controlled studio environment, where the audio is crisp, and the visual cues are well-lit and clearly framed. When applied to real-world recordings of live concerts, the same model may struggle due to background noise, varying lighting conditions, and occlusions in the video. Similarly, a time-series parsing model trained on clean, scripted dialogue from television broadcasts may fail when applied to spontaneous conversations in noisy environments, where speech is often interrupted, overlapping, or mixed with ambient sounds.

Another fundamental issue is temporal misalignment between modalities. In a well-structured source dataset, different modalities are often synchronized, enabling the model to learn precise cross-modal relationships. For example, a speech recognition model trained on lip movements and audio cues may expect perfect synchronization between visual and auditory inputs. However, in real-world applications, audio delays, network transmission latencies, and sensor inconsistencies frequently cause misalignment. In a surveillance video, the sound of a door slamming might be captured slightly before or after the corresponding motion in the video. Similarly, in wildlife monitoring, the sound of an animal call may be detected before the animal enters the camera frame, leading to inconsistencies in multi-modal correlation learned from a different dataset.

Beyond synchronization issues, many real-world datasets suffer from modality-specific noise and missing data. A model trained on a well-balanced dataset with both audio and video inputs may struggle when applied to a dataset where one modality is frequently missing or degraded. For instance, in vehicle detection systems, a training dataset may include both LIDAR and camera data, but in real-world conditions, fog, heavy rain, or sensor malfunctions may obscure one of the modalities. Similarly, an emotion recognition model trained with both facial expressions and vocal tone as inputs may not function properly when adapted to phone call recordings, where only audio is available. If a model has learned to rely too heavily on one modality, its performance may degrade significantly when that modality is unreliable or absent.

A related challenge is the shift in the relative importance of different modalities across domains. In some datasets, an event may be most easily identified using auditory cues, whereas in others, visual cues may be more reliable. For example, in one dataset, an approaching emergency vehicle may be best recognized by the sound of its siren. In another dataset, where background noise is prevalent, the model may need to rely more on flashing lights and vehicle movement patterns. A similar issue arises in sports analysis, where goal detection may rely on both crowd cheers and visual ball movement in one dataset, but only on visual cues in another dataset where audience reactions are muted or absent. When a model is trained in an environment where certain modalities provide dominant signals, it may struggle to adapt when those signals become weaker, inconsistent, or irrelevant in a different dataset.

Further complicating transfer learning for multi-modal time-series parsing are inconsistencies in feature representation across modalities. Different datasets may encode similar events using distinct feature extraction techniques, making it difficult to transfer knowledge across domains. For example, in human activity recognition, one dataset may represent movement using optical flow vectors, while another may use frame differencing techniques. Likewise, a speech recognition system trained on datasets where spoken commands are transcribed into text may perform poorly when applied to datasets where commands are represented as raw waveforms or phonetic encodings. These representation mismatches often require extensive re-training or fine-tuning, undermining the efficiency of transfer learning.

Accordingly, while transfer learning has proven effective for single-modality tasks, applying it to multi-modal time-series parsing with weakly labeled supervision remains a challenge. The difficulty of handling domain mismatches, variations in modality-specific event representation, temporal misalignment, missing or noisy modalities, and feature representation inconsistencies limit the effectiveness of current approaches.

### SUMMARY

Some embodiments disclose a system and method for training an inference model to detect events in multimodal data, such as audio-video or multi-sensor recordings, under weak supervision. Additionally, some embodiments enable event detection in a target domain where only a limited amount of training data is available. Weakly supervised learning allows models to be trained using imperfect, incomplete, or ambiguous labels rather than requiring fully detailed and precisely annotated data. This approach differs from fully supervised learning, where each training instance is explicitly labeled, and from unsupervised learning, where no labels are provided.

For clarity, many embodiments and examples in this disclosure illustrate the parsing of audio-video events; however, various embodiments extend to detecting events in other types of multimodal data. The scope of these embodiments includes, but is not limited to, applications involving different combinations of sensor inputs, ensuring broad applicability across multiple domains.

Weak supervision is particularly beneficial in scenarios where obtaining detailed labels is costly, time-intensive, or impractical. Applications such as video event detection, medical diagnosis, factory automation, and natural language processing often rely on coarse, noisy, or indirect labels rather than precisely labeled instances. Instead of requiring an annotation that specifies a person is speaking between the third and sixth seconds of a video, a weak label may only indicate that speech occurs somewhere in the video file. The challenge arises in bridging the gap between such broad annotations and the level of granularity required for effective model training.

Some embodiments are based on recognizing the challenges of transfer learning. In transfer learning, an inference model may first be pre-trained on data from a different source domain, where more detailed labels are available. The pre-trained model may then be adapted for the target domain using weakly supervised training data. In theory, this process allows the model to develop a foundational understanding of event structures before learning from the target domain's weaker supervision. In practice, however, pure transfer learning is not always optimal.

To that end, in some embodiments, additionally or alternatively to relying solely on a pre-trained inference model, the source domain may be leveraged to train a separate model that refines weak labels into structured pseudo-labels. These pseudo-labels provide more precise temporal localization of events, improving the model's ability to learn from the target domain. By transforming weak supervision into pseudo-supervised learning, this approach may offer advantages in certain practical applications.

Various embodiments build on the recognition that events exhibit temporal behavior and cross-modal correlations, forming a latent structure that can be learned in a latent space. Unlike raw data, which varies significantly between domains, this latent structure is often more uniform and transferable. For example, the way speech manifests in video data-through synchronized audio signals and facial movements-remains consistent across different datasets. If this structure is learned in a source domain and combined with weak labels from a target domain, the resulting pseudo-labels can offer the level of detail necessary for training an inference model with greater accuracy. Instead of simply indicating that a person is speaking at some point in a video, the model may infer that speech occurs between the third and sixth seconds, allowing for a more refined training process.

Some embodiments recognize that events do not occur in isolation but evolve over time. A sound or action typically extends across multiple segments rather than appearing as a discrete instance. The sound of a violin in a video does not arise in a single moment but persists across several seconds. A conversation spans multiple consecutive audio frames rather than being confined to a single timestamp. A car entering a video frame does not instantly appear in full size but moves progressively into view. In some embodiments, temporal attention mechanisms, such as transformers, are applied to infer missing fine-grained labels by capturing relationships between consecutive segments. This allows detected events to reflect continuity rather than appearing as fragmented or disconnected occurrences.

Generating a separate model for processing training data in the target domain to produce pseudo-labels allows for a distinction between the architecture of the inference model and the architecture of the pseudo-label generation model. This distinction permits the pseudo-labeling process to take advantage of advanced temporal modeling techniques that refine coarse labels into structured event annotations. By processing training data separately, pseudo-labels are improved, making them more suitable for supervised learning.

Some embodiments leverage cross-modal redundancy to compensate for weak or missing labels. In multimodal data, the same event may manifest across different modalities. A musical performance may be represented by both a visual cue, such as a person playing an instrument, and an audio signal, such as the sound of the instrument. A barking dog may be heard before it appears on screen. A thunderstorm may be seen as lightning before the accompanying sound of thunder reaches the microphone. These cross-modal dependencies allow the model to infer the presence of an event in one modality even when direct evidence is unavailable in another.

Additionally or alternatively, some embodiments address uncertainty in weak labels by recognizing that missing labels do not necessarily indicate the absence of an event but often reflect ambiguity. Many learning models assume that if an event is not explicitly labeled at a fine-grained level, it is not present. However, this assumption can result in systematic under-prediction of events. Since any given segment of multimodal data may contain only a small subset of possible event classes, models are naturally influenced to prioritize predicting the absence of events rather than their presence. In some embodiments, uncertainty-aware learning is used to mitigate this effect. High-confidence predictions may be propagated to neighboring segments to reinforce continuity, while lower-confidence predictions may contribute less to training, reducing overfitting. Pseudo-labels may be assigned different weights based on their confidence levels, allowing the model to focus on well-established patterns while refining more ambiguous cases.

To enhance training, some embodiments incorporate a transformer-based architecture that maintains temporal consistency in pseudo-label generation. Transformers encode relationships between video segments, enabling the model to recognize events as continuous rather than fragmented occurrences. In some embodiments, the transformer is pre-trained on a separate fully labeled dataset, allowing it to learn dependencies across time before being applied to weakly supervised training data. By structuring event annotations in this way, pseudo-label reliability is improved.

Some embodiments further refine pseudo-label accuracy by modeling both audio and visual modalities jointly. This enables the system to compensate for missing or incomplete information in one modality by leveraging signals from another. A siren, for example, may be heard before the corresponding emergency vehicle appears on screen. In such cases, cross-modal attention mechanisms allow the model to propagate label information across modalities, improving event detection performance.

In some embodiments, pseudo-labels are not treated as absolute ground truth but are dynamically adjusted based on confidence scores. Labels with high confidence may be assigned greater weight in training, while those with lower confidence may contribute less. This prevents the model from overfitting to uncertain labels while ensuring it learns from more reliable signals. By incorporating uncertainty into the training process, the model becomes more robust when handling noisy or weakly labeled data.

Some embodiments address generalization by employing a feature mixup regularization strategy. This technique creates augmented training samples by blending segment features and interpolating their corresponding labels. By mixing features from different segments, the model learns a smoother decision boundary and reduces over-reliance on any single training example. This prevents the model from becoming overly confident in potentially incorrect pseudo-labels, leading to more flexible and generalized learning.

To further improve model performance, some embodiments apply class-balanced loss reweighting. Weakly supervised datasets often contain a significantly higher number of non-event segments compared to event segments. Without correction, a model may develop a bias toward predicting the absence of events, resulting in poor detection performance. Some embodiments address this by adjusting the loss function to reweight contributions from underrepresented event classes, ensuring that both common and rare events are learned effectively.

By combining these techniques, some embodiments improve multi-modal time-series parsing under weak supervision. By leveraging temporal consistency, cross-modal relationships, and uncertainty-aware learning, the system refines pseudo-label generation, enhances model training, and produces more accurate event predictions. These embodiments extend beyond audio-visual parsing and may be applied to a range of weakly supervised learning tasks, including medical AI, autonomous vehicle perception, and speech processing, where fine-grained labels are challenging or costly to obtain.

Accordingly, some embodiments disclose a system and a method for multi-modal time-series parsing from weakly supervised data, using a processor and a memory storing instructions that, when executed by the processor, cause the processor to perform operations including receiving a training multi-modal input sequence comprising a plurality of segments, each segment including data from at least one modality; generating segment-level pseudo-labels by applying a pre-trained pseudo-label generation model, wherein the pseudo-label generation model: captures temporal dependencies between segments using a transformer-based architecture, and extracts cross-modal correlations between different modalities to refine pseudo-label accuracy; computing an uncertainty score for each generated pseudo-label based on a confidence measure derived from the predictions of the pseudo-label generation model; and training an inference model to predict whether an event is present in each segment of each modality within a test multi-modal input sequence, wherein the inference model is trained using uncertainty-weighted learning on the training multi-modal input sequence labeled with the pseudo-labels associated with the uncertainty scores.

### BRIEF DESCRIPTION OF THE DRAWINGS

The accompanying drawings, which are incorporated in and constitute a part of this specification, illustrate various embodiments of the disclosed system and method for uncertainty-weighted weakly-supervised multi-modal event parsing and serve to explain the principles of the disclosure.

FIG. 1 illustrates a schematic representation of a method for replacing or complementing traditional transfer learning with pseudo-supervised learning of multi-modal data, in accordance with some embodiments.

FIG. 2 depicts a schematic diagram of a method for generating pseudo-labels that provide structured information suitable for uncertainty-aware pseudo-supervised learning of an inference model for event parsing, in accordance with some embodiments.

FIG. 3 presents a block diagram of a computer-implemented method for multi-modal event parsing from weakly supervised data, illustrating how pseudo-label generation and uncertainty-aware training enhance event detection accuracy.

FIG. 4 shows an example schematic of transitioning from weak labels to uncertainty-aware training through an adjustment process, demonstrating how uncertainty scores are incorporated into training to improve pseudo-label reliability.

FIG. 5 illustrates a schematic representation of a method for training a pseudo-label generation model using a transformer-based architecture to extract meaningful representations from both audio and video data, in accordance with some embodiments.

FIG. 6 provides an overview of the training process for an inference model, such as the Hybrid Attention Network (HAN), using the pre-trained pseudo-label generation model from FIG. 5, highlighting the integration of multi-modal pseudo-labels for enhanced event classification.

FIG. 7 presents an exemplary computing device that is representative of any system or collection of systems in which the disclosed processes, programs, and methods may be implemented, illustrating various components including a processor, memory, software, and communication interfaces.

### DETAILED DESCRIPTION

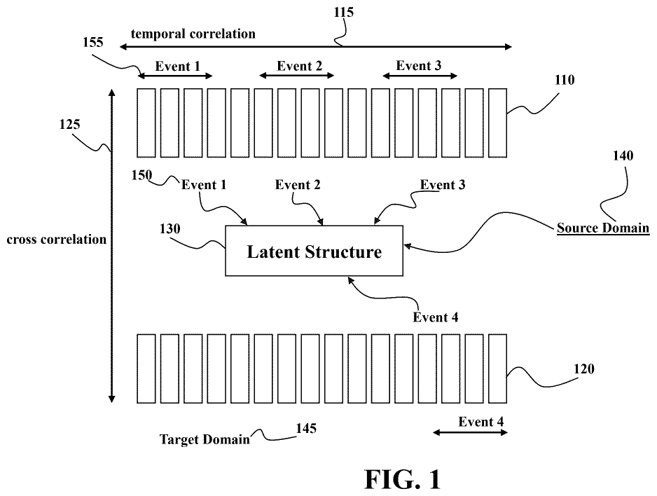

FIG. 1 shows a schematic of a method for replacing or complementing traditional transfer learning from the source domain 140 to the target domain 145 with pseudo-supervised learning of multi-modal data, in accordance with some embodiments. This approach refines weakly labeled events 150 into stronger pseudo-labels 155 by leveraging the latent structure 130 learned in the source domain. Through this process, the system captures both temporal dependencies 115 and cross-modal relationships 125 of the data, which enhances event detection accuracy in the target domain.

The system operates on multi-modal training data collected in the target domain, i.e., the domain of interest. The training data includes at least a first modality 110, such as visual frames, images, or video, and a second modality 120, which could be audio, sensor data, or text. These modalities work together to take advantage of the weak events 150 identified to be present within different segments of training data. In the source domain 140, a pseudo-label generation model is pre-trained on fully labeled data, where it captures both temporal correlations 115 and cross-modal dependencies 124 between different data segments. In contrast with the weak labels, the full labels identify the type and time of the events. By extracting a latent structure 130 that represents the underlying behavior of events rather than relying solely on explicit annotations, the model develops a deeper understanding of event representation.

Within the target domain 145, weak supervision results in event labels that are incomplete or ambiguous. To address this, the system utilizes the latent structure 130 learned in the source domain to refine weak labels 150 into strong pseudo-labels 155. This refinement process allows for improved localization of events, such as events 1, 2, 3, and 4, within the target domain across first modality frames 110 and second modality frames 120. The pseudo-label generation model employs transformer-based architectures to infer missing temporal relationships and cross-modal dependencies between segments, ensuring robust event detection under weak supervision.

Unlike or in addition to transfer learning, which directly applies a model trained on a source domain to a target domain, this approach dynamically infers pseudo-labels based on the learned latent structure. By doing so, it mitigates data mismatches, enhances cross-modal integration, and adapts to domain-specific variations. This approach enables more effective multi-modal time-series parsing, particularly in scenarios where labeled data is scarce, demonstrating a state-of-the-art advancement in weakly supervised learning methodologies.

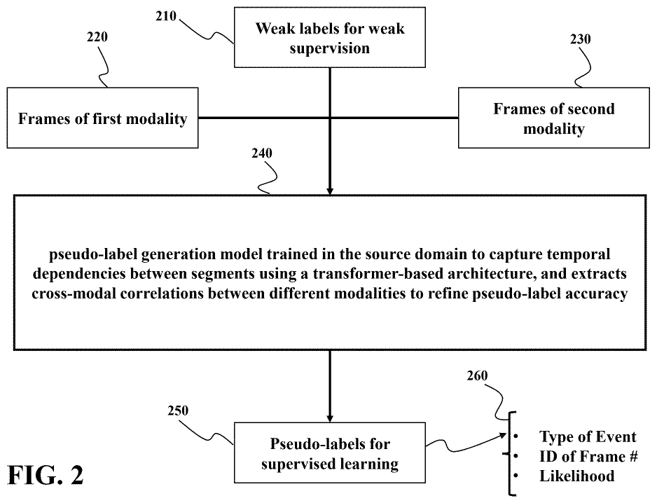

FIG. 2 shows a schematic of a method for generating pseudo-labels 250 that provides information suitable for uncertainty-aware pseudo-supervised learning of the inference model for event parsing, in accordance with some embodiments. This method is configured to operate on multi-modal data collected in the target domain, enabling a more refined approach to training inference models under weak supervision.

The method collects multi-modal data, which includes data from different modalities 220 and 230. These modalities can vary based on the application, but in many cases, they include video and audio data, sensor data, or text-based information. Along with this multi-modal data, weak labels of events are also gathered. These weak labels serve as coarse indicators of event occurrence but are often incomplete or ambiguous. For instance, in the case of audio-video data, weak labels are typically acquired only for video modality to indicate the presence of the events without identifying time of the events. However, other configurations are possible, where weak labels may be available for different or multiple modalities.

Once the data is collected, it is processed using a pre-trained pseudo-label generation model. This model assigns labels that identify the type and location of events 260 within the dataset. In addition to generating event labels, the model computes the likelihood of correctness associated with each identification. This likelihood score serves as a confidence measure, reflecting the reliability of the assigned labels.

The likelihood information is then integrated into the uncertainty-aware training of the inference model. This step transforms the challenge of replacing fully supervised labels with pseudo-labels into an advantage. By incorporating uncertainty into the training process, the model can weigh pseudo-labels based on their reliability, ensuring that more confident labels contribute more significantly to learning while less certain labels exert a weaker influence. This strategy improves the robustness of the inference model, allowing it to generalize better in scenarios where full supervision is not available.

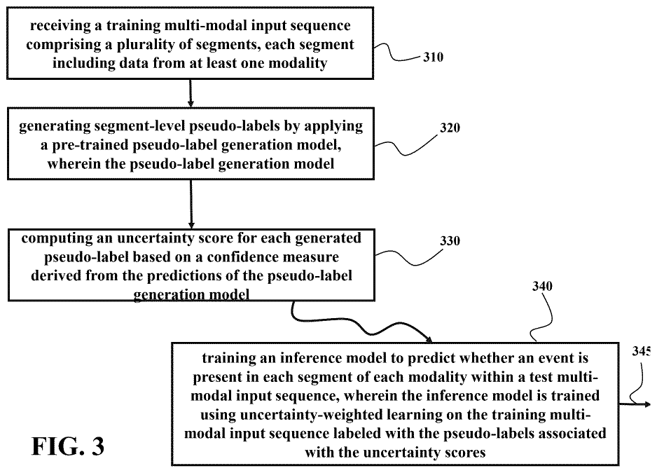

FIG. 3 shows a block diagram of a computer-implemented method for multi-modal time-series parsing from weakly supervised data, designed to enhance event detection accuracy by leveraging pseudo-label generation and uncertainty-aware training techniques, in accordance with some embodiments. This method enables the effective training of an inference model 345, even in scenarios where fully annotated datasets are unavailable, by refining weak supervision into structured, high-confidence pseudo-labels.

The process begins with receiving 310 a training multi-modal input sequence, partition into multiple segments, e.g., one second each. Each segment contains data from at least one modality, such as video, audio, sensor data, or text. This sequence serves as the foundation for learning event patterns across different modalities in the target domain.

Next, the method generates 320 segment-level pseudo-labels using a pre-trained pseudo-label generation model. This model incorporates advanced deep learning techniques, particularly a transformer-based architecture, to capture temporal dependencies between segments. Additionally, the pseudo-label generation model extracts cross-modal correlations by analyzing the relationships between different modalities, thereby improving the accuracy and coherence of pseudo-label assignments. This cross-modal integration allows the model to infer event presence even in cases where direct evidence is missing or weakly labeled.

Following pseudo-label generation, the method computes 330 an uncertainty score for each generated pseudo-label. This score is derived from a confidence measure based on the predictions of the pseudo-label generation model. By quantifying the reliability of each pseudo-label, the system ensures that more certain predictions contribute more heavily to the training process, while less reliable labels have a reduced influence. This approach prevents overfitting to potentially incorrect labels and enhances the robustness of the training process.

The next step involves training 340 an inference model in a pseudo-supervised manner using pseudo-labels to predict whether an event is present in each segment of each modality within a test multi-modal input sequence subsequently acquired in the target domain. Unlike other models that rely solely on supervised learning, this inference model is trained using uncertainty-weighted learning, where the training multi-modal input sequence is labeled with the pseudo-labels and their associated uncertainty scores. This methodology turns the challenge of weak supervision into an advantage, allowing the inference model to dynamically adjust its learning process based on the confidence levels of the pseudo-labels.

By integrating temporal modeling, cross-modal correlations, and uncertainty-aware training, this approach significantly improves the ability to parse multi-modal time-series with limited labeled data. The method is particularly advantageous in applications such as video event detection, speech recognition, medical diagnostics, and autonomous systems, where obtaining fully supervised training datasets is impractical or costly. Through the combination of structured pseudo-labeling and adaptive confidence-weighted learning, the system ensures improved generalization and robustness in real-world event parsing tasks.

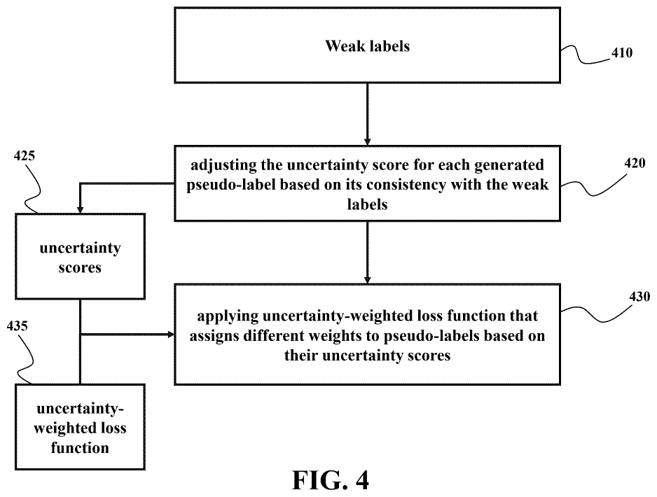

FIG. 4 illustrates an example schematic of a transition from weak labels 410 to uncertainty-aware training 430 through an adjustment process 420, in accordance with some embodiments. In some embodiments, the transition refines pseudo-labels based on their consistency with the weak labels 410 by determining an uncertainty score for each pseudo-label and incorporating the uncertainty into an uncertainty-weighted training process. The uncertainty-aware training 430 may employ an uncertainty-weighted loss function 435 that assigns different weights to pseudo-labels based on their uncertainty scores 425, allowing an inference model to be trained 430 using weakly supervised data while dynamically adjusting the influence of each pseudo-label based on its reliability.

In some implementations, weak labels 410 provide annotations indicating the occurrence of an event within a given video but may not specify when, where, or in which modality the event occurs. For example, in an audio-visual system, weak labels 410 may indicate that an event occurs within a video but do not specify whether it is present in the audio modality, the visual modality, or both. The lack of precise localization or modality-specific annotation may introduce ambiguity when parsing unimodal and multi-modal time-series that are not temporally aligned.

To refine the training data, the adjustment process 420 may apply a pseudo-label generation model to produce segment-level pseudo-labels. The pseudo-label generation model may be pre-trained on a dataset containing labeled examples and may be configured to learn temporal relationships and cross-modal correlations. In some embodiments, the model assigns an uncertainty score to each generated pseudo-label based on its consistency with the weak labels 410. The uncertainty score for each pseudo-label may be determined based on the deviation of a segment-level logit from a predefined threshold.

A logit refers to the raw, unnormalized output of a classification model before the application of an activation function such as the sigmoid or softmax function. The logit value is typically obtained from the final layer of a neural network and represents the model's confidence in predicting a specific event in a given segment. In the context of pseudo-label generation, the logit for a given segment is computed by taking the inner product between the segment-level feature vector and a class-specific feature representation. Mathematically, the logit

$${z}_{t}^{c}$$

for a segment t and event class c can be expressed as:

$${z}_{t}^{c} = {w}_{c} \cdot {f}_{t} , \qquad ( 1 )$$

where w_{c} represents the learned weight vector for class c, and fₜ is the feature vector extracted for the segment t. This formulation ensures that the logit value reflects the similarity between the segment's features and the class-specific representation.

To determine the uncertainty score, the logit is compared against a predefined threshold θ_{c}, which represents the minimum confidence level required to classify an event with certainty. The uncertainty score

$${u}_{t}^{c}$$

for a pseudo-ravel corresponding to class c in segment t is computed based on the deviation of the logit from the threshold is captured by the confidence score, shown below:

$${u}_{t}^{c} = \vert σ ( {z}_{t}^{c} ) - {θ}_{c} \vert ,$$

where

$$σ ( {z}_{t}^{c} )$$

is the sigmoid function applied to the logit:

$$σ ( {z}_{t}^{c} ) = \frac{1}{1 + {e}^{- {z}_{t}^{c}}} .$$

The sigmoid function transforms the logit into a probability value ranging between 0 and 1, allowing for easier interpretation of confidence levels. When

$$σ ( {z}_{t}^{c} )$$

is far from the threshold θ_{c}, the uncertainty score (as measured by the confidence score)

$${u}_{t}^{c}$$

is high, indicating high confidence in the prediction. Conversely, when

$$σ ( {z}_{t}^{c} )$$

is close to the threshold, the uncertainty score is low, signaling lower confidence in the prediction.

Once the uncertainty scores are determined, they are incorporated into the uncertainty-aware training 430 to modulate the influence of each pseudo-label in the loss function. In some embodiments, an uncertainty-weighted loss function assigns greater weight to pseudo-labels with high confidence scores, thereby allowing high-confidence pseudo-labels to exert greater influence on model learning. Pseudo-labels with lower scores may receive lower weight or be selectively excluded to prevent the model from overfitting to uncertain labels.

By integrating uncertainty-aware weighting, an inference model may improve its ability to generalize to new data while reducing the impact of weak supervision. This approach may be beneficial for various machine learning tasks, including but not limited to time-series parsing, classification, and object detection in multi-modal environments. The uncertainty-aware training 430 may also be extended to other training paradigms, such as semi-supervised learning, self-supervised learning, and transfer learning, where labeled data is limited.

As illustrated in FIG. 4, the transition from weak labels 410 to uncertainty-aware training 430 via adjustment 420 provides an approach to refining weakly supervised training data, reducing reliance on weak labels, and improving the performance of models trained with limited labeled data. Implementations of this method may incorporate dynamically adjusted uncertainty scores based on logit deviations from predefined thresholds to improve pseudo-label reliability, thereby enhancing model training and generalization capabilities.

### EXEMPLAR EMBODIMENTS

These embodiments illustrate training the pseudo-label generation model for weakly supervised audio-visual video parsing (AVVP). However, other embodiments extend the principles to train the pseudo-label generation model for other modalities.

The AVVP task aims to localize all visible and/or audible events in each one-second segment of a video. Specifically, an audible video is split into T one-second segments, denoted as

$${\{ {V}_{t} , {A}_{t} \}}_{t = 1}^{T} .$$

Each segment is annotated with a pair of ground-truth labels

$${y}_{t}^{v} ∈ {\{ 0 , 1 \}}^{C} , {y}_{t}^{a} ∈ {\{ 0 , 1 \}}^{C} , where {y}_{t}^{v}$$

denotes events with a visual imprint, while

$${y}_{t}^{a}$$

denotes the total number of events in the pre-defined event set of the data. However, owing to the weakly-supervised nature of the task setup

$$( {y}_{t}^{v} , {y}_{t}^{a} )$$

are unavailable during training. Instead, only the modality-agnostic, video-level labels y∈{0,1}^{C} are available, where 1 indicates the presence of an event at any time (either in the audio or the visual stream or both) while 0 indicates an event's absence in the video.

In some embodiments, the Hybrid Attention Network (HAN) is used as the inference model for the AVVP task. The model works by first utilizing pre-trained visual and audio backbones to extract features from the visual and audio segments respectively, which are then projected to two d-dimensional feature spaces. The resulting visual segment-level features are denoted by

$${F}^{v} = {\{ {f}_{t}^{v} \}}_{t = 1}^{T} ∈ {ℝ}^{T \times d} ,$$

while the audio segment-level features are denoted by

$${F}^{a} = {\{ {f}_{t}^{a} \}}_{t = 1}^{T} ∈ {ℝ}^{T \times d} .$$

These features are provided as input to the HAN model. In the model, information across segments within a modality and across modalities is exchanged through self-attention and cross-attention lavers, as shown below:

$${\tilde{f}}_{t}^{v} = {f}_{t}^{v} + {\underbrace{Attn ( {f}_{t}^{v} , {F}^{v} , {F}^{v} )}}_{Self - Attention} + {\underbrace{Attn ( {f}_{t}^{v} , {F}^{a} , {F}^{a} )}}_{Cross - Attention} , \qquad ( 1 )$$

$${\tilde{f}}_{t}^{a} = {f}_{t}^{a} + {\underbrace{Attn ( {f}_{t}^{a} , {F}^{a} , {F}^{a} )}}_{Self - Attention} + {\underbrace{Attn ( {f}_{t}^{a} , {F}^{v} , {F}^{v} )}}_{Cross - Attention} , \qquad ( 2 )$$

where Attn(Q, K, V) denotes the standard multi-head attention mechanism.

A classifier, shared across both modalities, transforms the visual segment-level features

$${\tilde{F}}^{v} = {\{ {\tilde{f}}_{t}^{v} \}}_{t = 1}^{T} ∈ {ℝ}^{T \times d}$$

(resp. audio segment-level features

$${\tilde{F}}^{a} = {\{ {\tilde{f}}_{t}^{a} \}}_{t = 1}^{T} )$$

into visual segment-level logits

$${\{ {z}_{t}^{v} \}}_{t = 1}^{T} ∈ {ℝ}^{T \times C}$$

(resp. audio segment-level logits

$${\{ {z}_{t}^{a} \}}_{t = 1}^{T} ) .$$

Segment-level probabilities

$${\{ {p}_{t}^{v} \}}_{t = 1}^{T} , {\{ {p}_{t}^{a} \}}_{t = 1}^{T} ∈ {ℝ}^{T \times C}$$

are then obtained by applying the sigmoid function on

$${\{ {z}_{t}^{v} \}}_{t = 1}^{T} and {\{ {z}_{t}^{a} \}}_{t = 1}^{T} .$$

In situations when, during training, only video-level labels y are available, the embodiments use an attentive Multi-modal Multiple Instance Learning (MMIL) pooling module to learn to predict video-level probabilities

$$p ∈ {ℝ}^{C} :$$

$${W}_{modal}^{v , a} = {Softmax}_{modal} ( {FC}_{modal} ( {\tilde{F}}^{v , a} ) ) , \qquad ( 3 )$$

$${W}_{time}^{v , a} = {Softmax}_{time} ( {FC}_{time} ( {\tilde{F}}^{v , a} ) ) , \qquad ( 4 )$$

where FC_{modal} and FCₜᵢₘₑ are two learnable fully-connected layers,

$${\tilde{F}}^{v , a} = Stack ( {\tilde{F}}^{v} , {\tilde{F}}^{a} ) ∈ {ℝ}^{2 \times T \times d}$$

denotes the stacked visual and audio features along the first dimension, Softmax_{modal}(⋅) denotes the softmax operation along the modality dimension (across v, a), while Softmaxₜᵢₘₑ(⋅) denotes the softmax operation along the temporal dimension (across 1, . . . , T). Video-level probabilities p∈ [symbol] , are then obtained via:

$$p = {Σ}_{m = \{ v , a \}} {Σ}_{t = 1}^{T} {W}_{modal}^{m , t} ⊙ {W}_{time}^{m , t} ⊙ {p}_{t}^{m} , \qquad ( 5 )$$

where ⊙ denotes the element-wise product. The HAN model is then optimized with the binary cross entropy (BCE) loss between the estimated video-level probabilities p and video-level labels y, as: [symbol] =BCE(p, y).

At a high level, Uncertainty-weighted Weakly-supervised Audio-visual Video Parsing (UWAV) works by generating better segment-level pseudo-labels for improved training of a multimodal transformer-based inference module, such as HAN. Moreover, factoring in the uncertainty associated with these estimated pseudo-labels and accounting for the imbalance in the training data while adding self-supervised regularization constraints leads to even better performances.

Some embodiments are based on the recognition that pseudo-label generation needs to capture the temporal relationships between neighboring segments when generating the pseudo-labels. To that end, some embodiments include transformer modules into the pseudo-label generation pipeline, which maps CLIP/CLAP encodings of a segment's visual frame/audio to pseudo-labels. Specifically, two separate transformers are introduced, one each for the visual/audio pseudo-label synthesis modules.

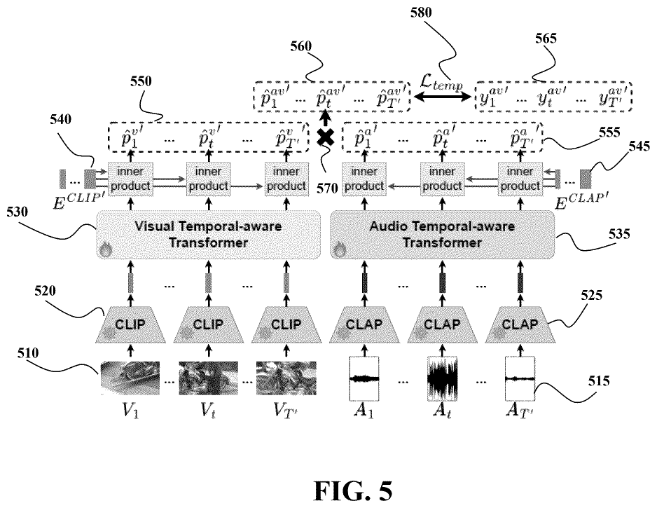

FIG. 5 illustrates a schematic representation of a method for training the pseudo-label generation model in accordance with some embodiments. This model leverages a transformer-based architecture to extract meaningful representations from both audio and video data, enabling a more robust pseudo-labeling process. Given the limited size of commonly used AVVP datasets, training a transformer directly on these datasets is often impractical. To address this, the pseudo-label generation module is first pre-trained on the large-scale supervised dataset UnAV, including video 510 and audio 515 data, which provides audio-visual event labels for each segment of a video. This pre-training phase allows the model to learn temporal relationships between segments and capture cross-modal correlations that improve pseudo-label accuracy.

The visual processing pipeline begins by splitting a given video into one-second segments 510, each centered around a keyframe. These frames are then encoded into feature representations using CLIP's image encoder 520, which extracts high-level visual information. The extracted features are subsequently passed through a transformer model 530 composed of L encoder blocks, each containing a self-attention mechanism 540 to learn dependencies across time, a layer normalization step for stabilizing training, and a two-layer feed-forward network for refining the feature representation 550.

Additionally, textual representations of event categories are generated using CLIP's text encoder 520, where each event name is embedded into a predefined caption template: “A photo of <EVENT NAME>.” The final visual segment-level logits 550 are computed as the dot product between the segment features and the event embeddings, followed by a sigmoid activation function to obtain probability estimates.

The audio processing pipeline operates in a parallel fashion. Each one-second audio segment 515 is first encoded into feature representations using CLAP's audio encoder 525, which extracts temporal and spectral characteristics from the waveform. These features are then processed through a transformer-based architecture 535 similar to the visual stream, with L encoder blocks that include self-attention layers 545, layer normalization, and feed-forward networks. To complement this, textual representations of event categories are generated using CLAP's text encoder (525, employing the template: “This is the sound of <EVENT NAME>.”) The resulting audio segment-level logits 555 are derived in the same manner as their visual counterparts, ensuring consistency between modalities.

To ensure that the pseudo-labels generated during training remain multimodal, the predicted segment-level probabilities from the visual and audio streams are multiplied 570. This step enforces the constraint that an event must be present in both modalities for it to be considered a valid occurrence. The network is then trained using a binary cross-entropy (BCE) loss function 580, which minimizes the error between the predicted audio-visual probabilities 560 and the ground-truth event labels 565. This training objective helps the model generalize better to weakly supervised AVVP datasets by learning to recognize consistent audio-visual patterns rather than relying on unimodal signals alone.

By pre-training on the UnAV dataset, the pseudo-label generation model becomes more effective at capturing complex relationships between audio and visual events. This approach mitigates the data scarcity issue in AVVP tasks by leveraging large-scale supervised data to inform pseudo-label predictions on smaller, weakly supervised datasets. As a result, the transformer-based architecture (530 and 535) enables more accurate event localization and classification, significantly improving the performance of the inference model. The use of cross-modal constraints and advanced transformer mechanisms ensures that the generated pseudo-labels maintain high fidelity, ultimately enhancing the overall AVVP framework.

Various variations of the above-mentioned training procedure are used by different embodiments. For example, one embodiment, given an audible video, from the pre-training dataset, of duration T′ seconds, splits the video into T′ one-second segments

$${\{ {V}_{t}^{′} , {A}_{t}^{′} \}}_{t = 1}^{T ′} ,$$

corresponding audio-visual event labels

$${y}_{t}^{av ′} ∈ {\{ 0 , 1 \}}^{C ′} ,$$

where 1 indicates the presence of a certain class in both modalities and 0 its absence in at least one modality, while C′ denotes the total number of event classes in the pre-training dataset. Next, the video frame at the temporal center of the visual segment is transformed into visual features G^{v′}∈ [symbol] ^{T′×d}^{₁} with CLIP's image encoder 520. These features are then fed into the corresponding transformer 530 of the visual stream, including L encoder blocks, each block containing a self-attention layer, LayerNorm (LN), and a 2-layer feed-forward network (FFN):

$${\tilde{G}}_{l}^{v ′} = LN ( {G}_{l}^{v ′} + Attn ( {G}_{l}^{v ′} , {G}_{l}^{v ′} , {G}_{l}^{v ′} ) ) , \qquad ( 6 )$$

$${G}_{l + 1}^{v ′} = LN ( {\tilde{G}}_{l}^{v ′} + FFN ( {\tilde{G}}_{l}^{v ′} ) ) . \qquad ( 7 )$$

Concurrently, the embodiment converts each event category label in the pre-training dataset into a textual event feature

$${e}_{c}^{CLIP ′} ∈ {ℝ}^{{d}_{1}}$$

by filling in the pre-defined caption template: “A photo of <EVENT NAME>” with the corresponding event name and passing it to CLIP's text encoder. Equipped with the visual segment-level features

$${G}_{L}^{v ′} = {\{ {g}_{t}^{v ′} \}}_{t = 1}^{T ′} ∈ {ℝ}^{T ′ \times {d}_{1}}$$

and the textual event features

$${E}^{CLIP ′} = {\{ {e}_{c}^{CLIP ′} \}}_{c = 1}^{C ′} ∈ {ℝ}^{C′ \times {d}_{1}} ,$$

corresponding to each of the event classes, we derive visual segment-level logits

$${\hat{z}}_{t}^{v ′} ∈ {ℝ}^{C ′}$$

and probabilities

$${\hat{p}}_{t}^{v ′}$$

as follows:

$${\hat{p}}_{t}^{v ′} = S i g m o i d ( {\hat{z}}_{t}^{v ′} ) , {\hat{z}}_{t}^{v ′} = {E}^{CLIP ′} \cdot {g}_{t}^{v ′ ⊤} . \qquad ( 8 )$$

Similar operations are performed in the audio pseudo-label generation pipeline. The raw waveforms corresponding to the 1-second audio segments are transformed into audio features G^{a′}∈ [symbol] with CLAP's audio encoder 525 and fed into the corresponding transformer made up of L encoder blocks. Correspondingly, the textual event features E^{CLAP′}∈ [symbol] are generated with the caption template: “This is the sound of <EVENT NAME>” by passing it through CLAP's text encoder. Audio segment-level logits

$${\hat{z}}_{t}^{a ′} ∈ {ℝ}^{C ′}$$

and probabilities

$${\hat{p}}_{t}^{a ′}$$

can then be derived in the same manner:

$${\hat{p}}_{t}^{a ′} = Sigmoid ( {\hat{z}}_{r}^{a ′} ) , {\hat{z}}_{r}^{a ′} = {E}^{CLAP ′} \cdot {g}_{t}^{a ′ T} .$$

Since the events occurring in the pre-training dataset (UnAV) are audio-visual, we multiply the segment-level visual and audio event probabilities to enforce the predicted labels to be multimodal in nature:

$${\{ {\hat{p}}_{t}^{av ′} \}}_{t = 1}^{T ′} ∈ {ℝ}^{T ′ \times C ′} .$$

This network is then trained with the binary cross entropy (BCE) loss:

$${ℒ}_{temp} = BCE ( {\hat{p}}_{t}^{av ′} , {y}_{t}^{av ′} ) , {\hat{p}}_{t}^{av ′} = {\hat{p}}_{t}^{v ′} ⊙ {\hat{p}}_{t}^{a ′} . \qquad ( 9 )$$

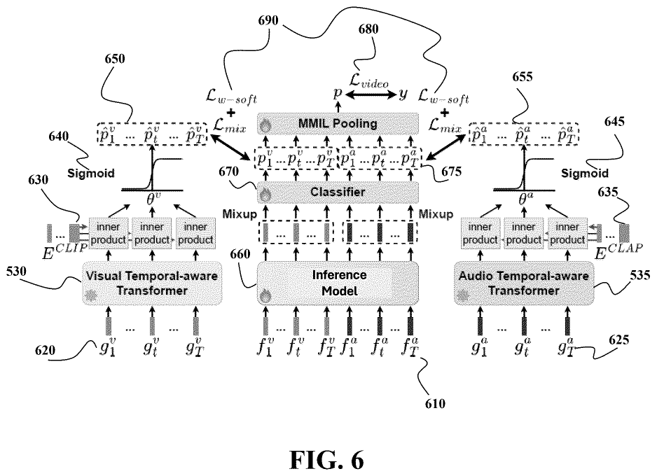

FIG. 6 illustrates the training process of the inference model, such as the Hybrid Attention Network (HAN), utilizing the pre-trained pseudo-label generation model from FIG. 5, in accordance with some embodiments. This process enables the inference model to learn from segment-level pseudo-labels generated using the previously trained transformer-based pseudo-label generation modules. By incorporating pseudo-labels into the training pipeline, the model benefits from richer supervision, enhancing its ability to parse and classify audio-visual events effectively.

The training begins with the pre-trained pseudo-label generation modules generating segment-level pseudo-labels 650 and 655 for the target dataset 610, including video and audio streams. Specifically, for the visual stream, the center frame of each one-second video segment is processed through CLIP's image encoder 520 producing an initial feature representation 620. This representation is then passed through the pre-trained visual transformer 530 to generate the final segment-level feature set:

$${G}_{L}^{v} = {\{ {g}_{t}^{v} \}}_{t = 1}^{T} ∈ {ℝ}^{T \times {d}_{1}} .$$

Simultaneously, textual features for each event class are obtained using the caption template: “A photo of <EVENT NAME>”. These textual event representations are processed through CLIP's text encoder, forming the set of class-wise textual embeddings 630 E^{CLIP}∈ [symbol] . Segment-level logits

$${\hat{z}}_{t}^{v} ∈ {ℝ}^{C}$$

are then computed as the inner product of the textual embeddings and the segment features:

$${\hat{z}}_{t}^{v} = {E}^{CLIP} \cdot {g}_{t}^{v ⊤} ,$$

determining event presence likelihoods.

To refine these logits into binary pseudo-labels 650, class-specific thresholds 640 θᵥ∈ [symbol] are pre-defined. A binary decision function is then applied:

$${\hat{y}}_{t}^{v} = {1}_{\{ {\hat{z}}_{t}^{v} > {θ}^{v} \}} ⊙ y ,$$

where y represents the ground-truth video-level labels, 1_{{⋅}} is the indicator function that returns 1 if the condition is met, otherwise 0, and ⊙ denotes the element-wise product operation. This operation ensures that only event classes present in the video-level ground-truth labels contribute to training, preventing incorrect associations.

A similar pseudo-labeling process is applied to the audio modality, where raw audio waveforms of the target dataset are encoded 525 using CLAP's audio encoder 525 and processed through the pre-trained audio transformer 535. The caption template: “This is the sound of <EVENT NAME>” is used to generate textual event features 635 E^{CLAP}∈ [symbol] , leading to the computation of audio segment-level logits 645

$${\hat{z}}_{r}^{a} ∈ {ℝ}^{C}$$

and corresponding binary pseudo-labels

$${\hat{y}}_{t}^{a} 655.$$

With both the audio and visual segment-level pseudo-labels in place, the inference model 660 is trained to predict 670 the presence of events within each segment 610. The model's predicted probabilities

$${\hat{p}}_{t}^{v} and {\hat{p}}_{t}^{a} 675$$

are compared against the generated pseudo-labels 650 and 655 using a binary cross-entropy (BCE) loss function 680:

$${L}_{hard} = BCE ( {p}_{t}^{v} , {\hat{y}}_{t}^{v} ) + BCE ( {p}_{t}^{a} , {\hat{y}}_{t}^{a} ) .$$

This training process refines the inference model's capacity to recognize multimodal event patterns by leveraging both learned pseudo-labels and weakly supervised video-level annotations. Through this approach, the inference model progressively improves its ability to classify and localize events in both visual and auditory streams, ultimately achieving a more accurate and generalizable AVVP framework.

For example, one embodiment, with the pre-trained pseudo-label generation modules in place, proceeds to employ the pseudo-label generation process in the target dataset for the AVVP task. The center frame of each of the visual segments

$${\{ {V}_{t} \}}_{t = 1}^{T}$$

of the target dataset are passed into CLIP's image encoder, whose output is then passed into the pre-trained, visual transformer to generate segment features

$${G}_{L}^{v} = {\{ {g}_{t}^{v} \}}_{t = 1}^{T} ∈ {ℝ}^{T \times {d}_{1}} .$$

At the same time, the caption template: “A photo of <EVENT NAME>” is used to obtain textual features corresponding to each of the event classes in the target dataset for the AVVP task: E^{CLIP}∈ [symbol] Segment-level visual logits

$${\hat{z}}_{t}^{v} ∈ {ℝ}^{C}$$

can then be derived by computing their inner product. We also pre-define class-wise visual thresholds θ^{v}∈ [symbol] , to transform segment-level visual logits into binary pseudo-labels

$${\hat{y}}_{t}^{v} ∈ {ℝ}^{C} : {\hat{y}}_{t}^{v} = {1}_{\{ {\hat{z}}_{t}^{v} > {θ}^{v} \}} ⊙ y , {\hat{z}}_{t}^{v} = {E}^{CLIP} \cdot {g}_{t}^{{v}^{T}} , \qquad ( 10 )$$

where y denotes the ground-truth video-level labels, 1_{{⋅}} is the indicator function which returns a value of 1 when the condition is true otherwise 0, and ⊙ denotes the element-wise product operation. The (operation zeroes out the predictions of event classes absent in the video-level label.

A similar pseudo-label generation process is employed on the acoustic side. Raw waveforms of audio segments are first fed into CLAP's audio encoder and then into the pre-trained audio transformer blocks. Event names of each of the classes of the target dataset for the AVVP task are filled in the caption template: “This is the sound of <EVENT NAME>” to generate textual event features: E_{CLAP}∈ [symbol] . Segment-level audio logits

$${\hat{z}}_{t}^{a} ∈ {ℝ}^{C}$$

and binary pseudo-labels

$${\hat{y}}_{t}^{a} ∈ {ℝ}^{C}$$

are then derived using class-wise thresholds θ^{a}∈ [symbol] .

With binary segment-level pseudo-labels for both modalities

$${\hat{y}}_{t}^{v} , {\hat{y}}_{t}^{a}$$

and the predicted probabilities from the inference (HAN) model,

$${\hat{p}}_{t}^{v} , {\hat{p}}_{t}^{a}$$

in place, the inference model can be trained using the binary cross entropy loss as shown:

$${ℒ}_{hard} = BCE ( {p}_{t}^{v} , {\hat{y}}_{t}^{v} ) + BCE ( {p}_{t}^{a} , {\hat{y}}_{t}^{a} ) . \qquad ( 11 )$$

Training with Pseudo-Label Uncertainty

While the use of pseudo-labels does provide additional supervision for better training of the inference module, yet the estimated pseudo-labels could potentially be noisy, leading to occasionally incorrect training signals. To ameliorate this problem, some embodiments use an uncertainty-weighted pseudo-label based training scheme to better train the inference module. Instead of simply training with the binary pseudo-labels

$${\hat{y}}_{t}^{v} , {\hat{y}}_{t}^{a} ,$$

the embodiment leverages the pseudo-label estimation module's confidence (associated with the predicted pseudo-label) to weigh the training signal of the inference module. This confidence score serves as a measure of the pseudo-label generation module's uncertainty of its prediction. This may be represented as:

$${\hat{p}}_{t}^{v} = Sigmoid ( {\hat{z}}_{t}^{v} - {θ}^{v} ) ⊙ y ; {\hat{p}}_{t}^{a} = Sigmoid ( {\hat{z}}_{t}^{a} - {θ}^{a} ) ⊙ y . \qquad ( 12 )$$

In other words, considering the visual pseudo-label generation pipeline as an example, the farther the logit

$${\hat{z}}_{t}^{v}$$

is from the threshold θ^{v}, (whether much lower or much higher), the more confident the pseudo-label generation module is about the label it predicted (either 0 or 1). Conversely, the closer the logit is to the threshold, the less the certainty about the correctness of the pseudo-labels (probabilities closer to 0.5). An analogous explanation also holds for the audio pseudo-labels. With the uncertainty-weighted pseudo-labels in-place, the training of the inference (HAN) module can proceed with the following uncertainty-weighted pseudo label based loss 690

$${ℒ}_{soft} = BCE ( {p}_{t}^{v} , {\hat{p}}_{t}^{v} ) + BCE ( {p}_{t}^{a} , {\hat{p}}_{t}^{a} ) . \qquad ( 13 )$$

### Uncertainty-Weighted Feature Mixup

Due to the lack of full supervision, for the weakly-supervised AVVP task, some embodiments explore the efficacy of additional regularization via self-supervision to help the models generalize better. Towards this end, prior pseudo-label generation-based approaches of some embodiments employ contrastive learning as a tool to better train the inference module. However, due to the inherent noise in the estimated pseudo-labels, positive samples and negative samples may be mislabeled, decreasing the effectiveness of the self-supervisory training.

As an alternative, some embodiments use feature mixing as a self-supervisory training signal for additional regularization. In this setting, the embodiments mixup the estimated features of any two segments, additively, and train the model to predict the union of the labels of the two segments. However, since the labels in our setting are noisy, the mixed feature is assigned a label derived from a weighted sum of the uncertainty-weighted pseudo-labels of each of the two segment features. This is illustrated below:

$${\overline{f}}_{{t}_{i} , {t}_{j}}^{v} = λ {\overline{f}}_{{t}_{i}}^{v} + ( 1 - λ ) {\tilde{f}}_{{t}_{j}}^{v} , {\overline{p}}_{{t}_{i} , {t}_{j}}^{v} = λ {\hat{p}}_{{t}_{i}}^{v} + ( 1 - λ ) {\hat{p}}_{{t}_{j}}^{v} \qquad ( 14 )$$

$${\overline{f}}_{{t}_{i} , {t}_{j}}^{a} = λ {\overline{f}}_{{t}_{i}}^{a} + ( 1 - λ ) {\tilde{f}}_{{t}_{j}}^{a} , {\overline{p}}_{{t}_{i} , {t}_{j}}^{a} = λ {\hat{p}}_{{t}_{i}}^{a} + ( 1 - λ ) {\hat{p}}_{{t}_{j}}^{a} \qquad ( 15 )$$

where λ~Beta(α, α) and α is a hyper-parameter controlling the Beta distribution and tᵢ and tⱼ indicate two segment indices in a batch of video segments.

After mixing the unimodal segment-level features, we pass them through the classifier of the inference module and apply the sigmoid function to the output, to obtain mixed segment-level event probabilities

$${p}_{t}^{m i x - v} and {p}_{t}^{m i x - a} .$$

This is then used to train the inference model with the uncertainty-aware mixup loss, as shown below:

$${ℒ}_{m i x} = B C E ( {p}_{t}^{m i x - v} , {\overline{p}}_{t}^{v} ) + B C E ( {p}_{t}^{m i x - a} , {\overline{p}}_{t}^{a} ) . \qquad ( 16 )$$

### Class-Balanced Loss Re-Weighting

Besides the aforementioned challenges of the AVVP task, most of the events in the event set are absent in the pseudo-labels of any (segment of a) video (most event classes are negative events) and only a few events are present (positive events are much fewer in number). As a result, the model is dominated by the loss from the negative events. When trained without factoring in this bias, the classifier tends to overfit negative labels and ignores the positive ones. To address this class imbalance issue, some embodiments use a class-balanced loss re-weighting strategy to re-balance the importance of the losses from the negative and positive events for the uncertainty-weighted pseudo-label loss.

Specifically, the loss from the positive events is multiplied by a weight proportional to the frequency of the segments with the negative events in the pseudo-labels, while the loss from the negative events is multiplied by a weight proportional to the frequency of the segments with the positive events in the pseudo-labels, as shown below:

$${ℒ}_{w - soft} = {\sum }_{m ∈ \{ v , a \}} {w}_{pos}^{m} \cdot y \cdot BCE ( {p}_{t}^{m} , {\hat{p}}_{t}^{m} ) + {w}_{n e g}^{m} \cdot ( 1 - y ) \cdot BCE ( {p}_{t}^{m} , {\hat{p}}_{t}^{m} ) , \qquad ( 17 )$$

$${w}_{p o s}^{m} = \frac{{\sum }_{i = 1}^{N} {\sum }_{t = 1}^{T} {\sum }_{c = 1}^{C} ( 1 - {\hat{y}}_{i , t , c}^{m} )}{NTC} \times W , \qquad ( 18 )$$

$${w}_{n e g}^{m} = \frac{{\sum }_{i = 1}^{N} {\sum }_{t = 1}^{T} {\sum }_{C = 1}^{C} {\hat{y}}_{i , t , c}^{m}}{NTC} , \qquad ( 19 )$$

where N denotes the number of videos in the training set, W is a hyper-parameter.

In summary, the inference model is trained on the AVVP task with the proposed class-balanced re-weighting applied to the uncertainty-weighted classification loss and the uncertainty-weighted feature mixup loss, as shown below:

$${ℒ}_{total} = {ℒ}_{w - soft} + {ℒ}_{m i x} + {ℒ}_{video} . \qquad ( 20 )$$

### Exemplar Solutions

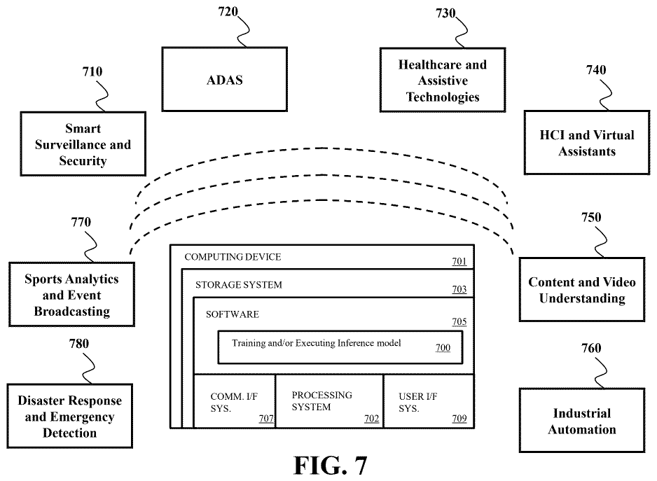

FIG. 7 shows a schematic of computing device 701 that is representative of any system or collection of systems in which the various processes, programs, services, and scenarios of some embodiments disclosed herein are implemented. Examples of computing device 701 include, but are not limited to, desktop and laptop computers, tablet computers, mobile computers, server computers, web servers, cloud computing platforms, and data center equipment, as well as any other type of physical or virtual server machine, container, and any variation or combination thereof.

Computing device 701 may be implemented as a single apparatus, system, or device or may be implemented in a distributed manner as multiple apparatuses, systems, or devices. Computing device 701 includes, but is not limited to, processing system 702, storage system 703, software 705, communication interface system 707, and user interface system 709. Processing system 702 is operatively coupled with storage system 703, communication interface system 707, and user interface system 709.

Processing system 702 loads and executes software 705 from storage system 703. Software 705 includes and implements principles of training and executing the inference model 700 described in various exemplar embodiments. When executed by processing system 702, software 705 directs processing system 702 to operate as described herein for at least the various processes, operational scenarios, and sequences discussed in the foregoing implementations. Computing device 701 may optionally include additional devices, features, or functionality not discussed for purposes of brevity.

Referring still to FIG. 7, processing system 702 may comprise a micro-processor and other circuitry that retrieves and executes software 705 from storage system 703. Processing system 702 may be implemented within a single processing device but may also be distributed across multiple processing devices or sub-systems that cooperate in executing program instructions. Examples of processing system 702 include general purpose central processing units, graphical processing units, digital signal processors, application specific processors, and logic devices, as well as any other type of processing device, combinations, or variations thereof.

Storage system 703 may comprise any computer readable storage media readable by processing system 702 and capable of storing software 705. Storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory, and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 703 may also include computer readable communication media over which at least some of software 705 may be communicated internally or externally. Storage system 703 may be implemented as a single storage device but may also be implemented across multiple storage devices or sub-systems co-located or distributed relative to each other. Storage system 703 may comprise additional elements, such as a controller, capable of communicating with processing system 702 or possibly other systems.

Software 705 may be implemented in program instructions and among other functions may, when executed by processing system 702, direct processing system 702 to operate as described with respect to the various operational scenarios, sequences, frameworks, and processes illustrated and/or discussed herein. For example, software 705 may include program instructions for implementing the sampling, training, and/or rendering processes described herein, as well as the probabilistic guided sampling discussed herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 705 may include additional processes, programs, or components, such as operating system software, virtualization software, or other application software. Software 705 may also comprise firmware or some other form of machine-readable processing instructions executable by processing system 702.

In general, software 705 may, when loaded into processing system 702 and executed, transform a suitable apparatus, system, or device (of which computing device 701 is representative) overall from a general-purpose computing system into a special-purpose computing system customized to perform computer vision processes in an optimized manner. Indeed, encoding software 705 on storage system 703 may transform the physical structure of storage system 703. The specific transformation of the physical structure may depend on various factors in different implementations of this description. Examples of such factors may include, but are not limited to, the technology used to implement the storage media of storage system 703 and whether the computer-storage media are characterized as primary or secondary storage, as well as other factors.

For example, if the computer readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 707 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 701 and other computing systems, may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

The inference model trained on multi-modal data using the pseudo-label generation process described above has several practical applications across various domains where audio-visual event understanding is critical. The inference model trained according to the principles of various embodiments can be used, but not limited to, the following applications.

One of the impactful applications of a multi-modal inference model is in intelligent surveillance and security systems 710, where the integration of video and audio data enhances event detection and classification. Traditional surveillance systems often rely solely on visual cues, which can be limiting, especially in scenarios where visibility is obstructed or an incident occurs outside the camera's field of view. By incorporating both audio and video inputs, the model improves accuracy in identifying potential threats and anomalies in public spaces such as airports, shopping centers, and transit hubs. For example, it can detect and classify shots, screams, or physical altercations, even when they are partially obscured or occur in low-light conditions. Additionally, the model can recognize complex multi-modal events, such as detecting both the visual cue of smoke and the sound of a fire alarm, ensuring faster and more reliable emergency responses. Similarly, in the case of an automobile accident, it can correlate the visual impact with the accompanying sound of a collision, helping authorities respond more efficiently. By leveraging this advanced detection capability, security and monitoring systems can issue real-time alerts, enabling rapid intervention and enhancing overall public safety.

Autonomous vehicles and Advanced Driver Assistance Systems (ADAS) 720 rely on multi-modal data to perceive and interpret their surroundings with greater accuracy and situational awareness. Traditional vehicle sensors, such as cameras and LiDAR, provide valuable visual input, but integrating audio data enhances detection capabilities, particularly in dynamic and unpredictable environments. The inference model strengthens these systems by identifying emergency sirens and detecting approaching emergency vehicles even before they enter the driver's or camera's field of view, allowing for proactive maneuvers. Similarly, it enhances pedestrian safety by recognizing movement patterns in conjunction with environmental sounds, such as a person shouting or a car honking, enabling the vehicle to respond to potential hazards more effectively.

Beyond safety, the model also improves real-time decision-making for autonomous driving by correlating visual road conditions with relevant audio cues. For example, in scenarios involving poor visibility, such as heavy fog or nighttime driving, the system can use auditory signals to supplement missing visual information, ensuring a more comprehensive understanding of the environment. Additionally, it can differentiate between routine road noise and critical auditory cues, such as construction alerts or approaching motorcycles, refining its ability to anticipate and react to complex driving situations. By leveraging both visual and auditory intelligence, multi-modal inference models make autonomous driving safer, more adaptive, and better equipped to navigate real-world challenges.

In the healthcare sector 730, multi-modal inference models play a transformative role in assistive technologies, particularly for individuals with hearing or visual impairments. By integrating both audio and visual data, these systems enhance patient monitoring, safety, and accessibility in various medical and home care settings. For instance, in elderly care facilities, the model can detect falls using video feeds while simultaneously analyzing distress sounds, such as a patient calling for help, ensuring timely intervention. Similarly, in intensive care units (ICUs) or remote patient monitoring systems, the model can identify irregular breathing patterns, sudden movements, or distress signals, enabling medical staff to respond proactively to emergencies.

Beyond patient monitoring, these models significantly improve accessibility for individuals with disabilities. Speech and gesture recognition systems enhanced by multi-modal learning allow users to interact more naturally with AI-powered assistive devices, making smart home environments more inclusive. For example, a person with limited mobility can issue both voice and gesture commands to control household appliances or request assistance. This technology also benefits individuals with speech impairments by combining lip-reading with voice recognition to improve communication accuracy. By leveraging the power of multi-modal data, these inference models drive advancements in patient care, accessibility, and emergency response, ultimately improving quality of life and medical outcomes.

Multi-modal inference models are reforming human-computer interaction (HCI) and virtual assistants 740, making them more intuitive, responsive, and context-aware. Traditional voice-controlled systems often struggle in noisy environments, but by integrating gesture recognition with speech commands, multi-modal models significantly enhance their accuracy and usability. For instance, a smart home assistant can interpret both verbal instructions and accompanying hand gestures, ensuring seamless interaction even when background noise interferes with speech recognition. This capability is particularly beneficial for users with speech impairments or those in environments where verbal communication alone may be insufficient.

Beyond voice control, multi-modal models improve contextual understanding in video conferencing AI, where they analyze facial expressions and tone of voice to detect speaker emotions and engagement levels. This enhances real-time interactions by enabling AI-driven moderation, automated sentiment analysis, and adaptive responses. Additionally, in augmented reality (AR) and virtual reality (VR) applications, these models enhance real-time immersive experiences by processing both visual and auditory cues, enabling more natural interactions in virtual environments. Whether in gaming, training simulations, or remote collaboration, multi-modal AI facilitates a more intuitive and responsive digital experience, bridging the gap between human intent and machine understanding.

Multi-modal inference models are transforming content moderation and video understanding 750 on digital platforms by providing more accurate and context-aware analysis of online media. Unlike systems that rely solely on text or visual data, these models integrate both audio and video cues to detect and flag inappropriate content with greater precision. For instance, they can identify hate speech not just from captions or transcripts but also from tone and context, while simultaneously analyzing visual elements to detect violent scenes, explicit imagery, or unsafe behaviors. This enhances automated moderation on social media platforms, video-sharing sites, and live-streaming services, ensuring safer digital environments.

Beyond moderation, these models improve video summarization and media retrieval. By recognizing and segmenting meaningful events within lengthy video streams, they can automatically generate concise summaries, making it easier for users to navigate and understand content efficiently. Additionally, they enhance multi-modal search capabilities, allowing users to search for specific events using both textual and audio-visual descriptions. For example, a user could search for “a person playing the violin while an audience claps,” and the system would retrieve relevant video segments based on both visual actions and accompanying sounds. By enabling smarter content analysis, retrieval, and moderation, multi-modal inference models are shaping the future of digital media management.

Multi-modal inference models of some embodiments benefit industrial automation and workplace safety 760, enhancing operational efficiency and reducing risks in hazardous environments. Traditional monitoring systems often rely on either visual inspections or sensor-based alerts, but by integrating audio-visual data, these models can provide a more comprehensive assessment of industrial conditions. For example, they can detect machine malfunctions by identifying abnormal sounds, unusual vibrations, or deviations in visual patterns, allowing for early intervention before failures escalate. This capability minimizes downtime and prevents costly damage, improving overall productivity in manufacturing and industrial operations.

In addition to equipment monitoring, multi-modal models enhance predictive maintenance systems by identifying early warning signs of equipment failure through combined visual, acoustic, and sensor data analysis. This enables proactive maintenance, reducing unexpected breakdowns and extending the lifespan of machinery. Furthermore, these models improve workplace safety compliance by ensuring that workers adhere to safety protocols. For instance, they can verify whether employees are wearing protective gear such as helmets and gloves while simultaneously detecting alarm sounds, gas leaks, or other hazardous warnings in real-time. By leveraging advanced AI-driven monitoring, industrial facilities can create a safer, more efficient, and compliant work environment, reducing workplace accidents and optimizing operational workflows.

Some embodiments use the multi-modal inference models for sports analytics and event broadcasting 770, enabling more precise event detection, enhanced viewer engagement, and AI-driven commentary. By integrating both video and crowd audio, these models can automatically identify key game events, such as goals, fouls, player interactions, and referee decisions, in real-time. For instance, the system can detect a goal not only from the ball crossing the line but also from the rise in crowd noise and the referee's whistle, ensuring accurate and timely event recognition. This capability enhances game analysis for coaches, analysts, and sports organizations, providing deeper insights into player performance and team strategies.

In sports broadcasting, multi-modal AI improves real-time contextual understanding, adding depth to live coverage. By analyzing player body language, facial expressions, and crowd reactions, the model can infer momentum shifts, team morale, and player emotions, delivering a richer storytelling experience. Additionally, AI-driven commentators can leverage these insights to analyze play patterns, recognize tactical adjustments, and integrate audio cues like coach instructions or on-field sounds to provide more immersive and dynamic commentary. Whether for automated highlight generation, audience engagement, or advanced coaching insights, multi-modal inference models are shaping the future of sports broadcasting and analytics, making the game more interactive and data driven.

In some embodiments, the multi-modal inference models are applied for disaster response and emergency detection 780, enabling faster, more accurate identification of critical situations and improving the efficiency of rescue operations. Traditional emergency detection systems often rely on either visual surveillance or sensor-based alerts, but by integrating audio-visual data, these models provide a more comprehensive and timely assessment of disasters. For example, the system can identify early signs of natural disasters, such as detecting earthquake tremors in video footage while simultaneously recognizing the rumbling sounds of shifting structures or underground movements. This early detection allows authorities to issue warnings and mobilize response teams before the situation escalates.

Beyond disaster prediction, these models play a role in search-and-rescue operations by detecting distress signals from survivors in collapsed buildings or disaster zones. Even when victims are not visible, the system can recognize calls for help, tapping sounds, or irregular breathing patterns, providing critical location data to rescue teams. Additionally, in large-scale emergencies such as floods, wildfires, or industrial accidents, multi-modal AI can track survivors, identify dangerous conditions, and assist first responders in navigating hazardous environments. By leveraging advanced event detection across multiple modalities, these models enhance situational awareness, speed up rescue operations, and ultimately save lives in emergency situations.

In effect, the trained inference model using pseudo-label generation in a multi-modal setting improves event detection and classification across numerous real-world applications. From security and surveillance to healthcare, autonomous systems, industrial safety, and entertainment, the model provides enhanced situational awareness, better decision-making, and improved accuracy over traditional unimodal AI systems. By integrating both audio and visual event understanding and/or other modalities, this approach paves the way for more intelligent, adaptive, and context-aware AI solutions.

As will be appreciated by one skilled in the art, aspects of the present disclosure may be embodied as a system, method or computer program product. Hence, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the disclosure is not limited to the specific embodiments described above, but only by the claims and their equivalents.

Claimed is:

1. A computer-implemented method for multi-modal time-series parsing from weakly supervised data, wherein the method uses a processor coupled with stored instructions implementing the method, wherein the instructions, when executed by the processor carry out steps of the method, comprising:
receiving a training multi-modal input sequence comprising a plurality of segments, each segment including data from at least one modality;
generating segment-level pseudo-labels by applying a pre-trained pseudo-label generation model, wherein the pseudo-label generation model: captures temporal dependencies between segments using a transformer-based architecture, and extracts cross-modal correlations between different modalities to refine pseudo-label accuracy;
computing an uncertainty score for each generated pseudo-label based on a confidence measure derived from predictions of the pseudo-label generation model; and
training an inference model to predict whether an event is present in each segment of each modality within a test multi-modal input sequence, wherein the inference model is trained using uncertainty-weighted learning on the training multi-modal input sequence labeled with the pseudo-labels associated with the uncertainty scores.

2. The method of claim 1, wherein the uncertainty-weighted learning includes an uncertainty-weighted loss function that assigns different weights to pseudo-labels based on their uncertainty scores, and a feature mixup regularization technique that generates augmented training samples by interpolating segment features and their corresponding uncertainty-weighted labels.

3. The method of claim 2, wherein the uncertainty-weighted learning includes
applying a class-balanced loss reweighting strategy to adjust the relative importance of event-present and event-absent labels.

4. The method of claim 3, wherein the class-balanced loss reweighting strategy assigns a higher weight to underrepresented event classes to mitigate dataset imbalance.

5. The method of claim 1, wherein the pseudo-label generation model is pre-trained on a large-scale, fully supervised dataset prior to being applied to weakly supervised data.

6. The method of claim 1, wherein the uncertainty score for each pseudo-label is determined based on the deviation of the segment-level logit from a predefined threshold.

7. The method of claim 1, wherein the training multi-modal input sequence includes audio-visual frames.

8. The method of claim 1, wherein the training multi-modal input sequence is associated with weak labels, and the pseudo-label generation model adjusts the uncertainty score for each generated pseudo-label based on its consistency with the weak labels.

9. The method of claim 1, wherein the multi-modal time-series parsing from weakly supervised data includes parsing audio-visual events from audio-video data.

10. The method of claim 1, wherein the transformer-based architecture of the pseudo-label generation model is pre-trained using a large-scale, fully supervised audio-visual event localization dataset.

11. The method of claim 1, wherein the pseudo-label generation model applies a temporal consistency constraint across sequential segments to enforce smooth and coherent pseudo-label predictions over time.

12. The method of claim 1, wherein the uncertainty-weighted loss function incorporates class-balanced loss reweighting to mitigate dataset imbalance by assigning higher weights to underrepresented event classes.

13. The method of claim 1, wherein the feature mixup regularization technique interpolates features across segments while applying an uncertainty-aware weighting scheme.

14. The method of claim 1, wherein the inference model applies modality-aware attention mechanisms to dynamically adjust the contribution of different modalities based on their respective pseudo-label confidence scores.

15. The method of claim 1, wherein the trained inference model is deployed in a real-time surveillance system to detect security threats by identifying unusual or dangerous activities.

16. The method of claim 1, wherein the trained inference model is integrated into autonomous vehicle systems to enhance situational awareness by detecting approaching emergency vehicles through the recognition of siren sounds and flashing lights and by identifying pedestrian activity based on both movement patterns and environmental sounds.

17. The method of claim 1, wherein the trained inference model is used in industrial automation and workplace safety systems to monitor compliance with safety regulations.

18. The method of claim 1, wherein the trained inference model is applied in video content analysis and moderation to detect and filter inappropriate or harmful content by simultaneously analyzing visual frames and audio signals to identify violent scenes, explicit language, or other restricted content.

19. The method of claim 1, wherein the trained inference model is integrated into a virtual assistant system to enhance user interactions by combining speech recognition with gesture detection, enabling more accurate command execution in noisy environments and improving accessibility for users with speech or hearing impairments.

20. A system for multi-modal time-series parsing from weakly supervised data, the system comprising: a processor; and a memory storing instructions that, when executed by the processor, cause the processor to perform operations comprising:
receiving a training multi-modal input sequence comprising a plurality of segments, each segment including data from at least one modality;
generating segment-level pseudo-labels by applying a pre-trained pseudo-label generation model, wherein the pseudo-label generation model: captures temporal dependencies between segments using a transformer-based architecture, and extracts cross-modal correlations between different modalities to refine pseudo-label accuracy;
computing an uncertainty score for each generated pseudo-label based on a confidence measure derived from the predictions of the pseudo-label generation model; and
training an inference model to predict whether an event is present in each segment of each modality within a test multi-modal input sequence, wherein the inference model is trained using uncertainty-weighted learning on the training multi-modal input sequence labeled with the pseudo-labels associated with the uncertainty scores.
